(19) United States
(12) Patent Application Publication
(10) Pub. No.: US 2011/0243368 A1
(43) Pub. Date: Oct. 6, 2011

(54) MULTIFUNCTIONAL MICRO SPEAKER

(75) Inventors: Sung-Hwan Doh, Gyeonggi-do (KR); Jae-Kyung Song, Seoul (KR); Jin-Hyuk Hong, Seoul (KR)

(73) Assignee: BSE CO., LTD., Incheon (KR)

(21) Appl. No.: 13/139,937

(22) PCT Filed: Aug. 31, 2009
(86) PCT No.: PCT/KR2009/004880

§ 371 Date: Jun. 15, 2011

(30) Foreign Application Priority Data
Jun. 24, 2009 (KR) 10-2009-0056548

(51) Int. Cl. H04R 1/00

(52) U.S. Cl. 381/398

(57) ABSTRACT

A multifunctional micro speaker including a frame including a lower plate portion and a lateral wall portion; a diaphragm having an outer circumferential portion that is fixed to the lateral wall portion of the frame; a voice coil fixed to a lower surface of the diaphragm; a suspension including a central portion and a supporting portion, wherein the central portion has a lower surface that is closely fixed to a lower plate member disposed in a lower portion of the frame, and the supporting portion extends from at least a portion of an outer circumferential portion of the central portion and is bent; a yoke fixed to the supporting portion of the suspension; a permanent magnet fixed to a bottom surface of the yoke; and a plate fixed to an upper surface of the permanent magnet.

### CROSS-REFERENCE TO RELATED PATENT APPLICATION

This application claims the benefit of Korean Patent Applications No. 10-2009-0056548, filed on Jun. 24, 2009, in the Korean Intellectual Property Office, and the benefit of International Patent Application No. PCT/KR2009/004880, filed on Aug. 31, 2009, in the Korean Intellectual Property Office, the disclosures of which are incorporated herein in their entirety by reference.

### BACKGROUND OF THE INVENTION

1. Field of the Invention

One or more aspects of the present invention relate to multifunctional micro speakers, and more particularly, to a multifunctional micro speaker that includes a suspension for supporting a speaker magnetic circuit and having an improved shape, thereby preventing an unstable vibration of the speaker magnetic circuit.

2. Description of the Related Art

A speaker is a device for converting an electrical signal into a voice signal. A micro speaker is a small-sized speaker used in small-sized portable audio devices such as cellular phones, notebook computers, MP3 players, earphones, and the like. Demand for such devices has risen sharply recently.

However, conventional electrical products employing a micro speaker, in particular, mobile communication devices such as cellular phones, indispensably include a component for generating a vibration. That is, a conventional mobile communication device includes a component for generating a vibration that is frequently used instead of a sound to indicate an incoming call, or includes a component for generating a vibration to indicate an input state in a touch screen method in which information is input directly by touching a screen.

A multifunctional micro speaker as claimed in the present application further includes a component for generating a vibration, in addition to including a component for generating a sound as in a conventional micro speaker. A multifunctional micro speaker is variously referred to as a multifunctional actuator, a multifunctional electrical sound converter, or the like.

A conventional multifunctional micro speaker is configured to generate a vibration by making a vibrator supported by a plate-type spring resonate. The conventional multifunctional micro speaker includes a voice coil disposed in a magnetic circuit at a side of a diaphragm that is also referred to as a reed. Thus, when a voice signal current is supplied to the voice coil, the reed vibrates, and a sound is output. In addition, when a vibration signal current is supplied to the voice coil, the magnetic circuit vibrates, and a vibration is generated by a vibrator (which includes a yoke, a permanent magnet, and a plate).

A conventional multifunctional micro speaker 100 will now be described with reference to FIG. 1. The conventional multifunctional micro speaker 100 includes a case 110, a diaphragm 101 for generating a sound, a voice coil 102, a permanent magnet 104 of which N and S poles are vertically aligned, a plate 103, a yoke 105, and a suspension 106. A current is supplied to the voice coil 102 through a lead wire a 114 and a lead wire b 115.

An upper end portion of the voice coil 102 is fixed to a lower surface of the diaphragm 101. The voice coil 102 is wound in a downward direction. The plate 103 is fixed to an upper surface of the permanent magnet 104. The permanent magnet 104, the plate 103, and the yoke 105 constitute a speaker magnetic circuit, and simultaneously, constitute a vibrator for generating a vibration. The yoke 105 is elastically supported against the case 110 by the suspension 106 with a through hole formed therethrough, which has a cylindrical shape.

When a current is supplied to the voice coil 102 of the conventional multifunctional micro speaker 100 through the lead wire a 114 and the lead wire b 115, an electromagnetic force is generated in the voice coil 102 in the speaker magnetic circuit, and thus, the diaphragm 101 vibrates and a sound is output. When a vibration signal current is supplied to the voice coil 102 through the lead wire a 114 and the lead wire b 115, the vibration signal current triggers an up-and-down motion of the speaker magnetic circuit (the vibrator) including the permanent magnet 104, the plate 103, and the yoke 105, to thus generate a vibration.

However, a general conventional multifunctional micro speaker includes a suspension for supporting a magnetic circuit as a vibrator. In this case, the suspension has a plate shape. A flatness of the suspension may be deformed due to material forming the suspension, or during processing and manufacturing of the suspension, and thus an unstable vibration may be generated.

Since the suspension has a plate shape, a thickness of the suspension, or a shape of a cut portion of a plate is inevitably changed in order to control a vibration resonance frequency.

Damping of the magnetic circuit constituting the vibrator is controlled according to the thickness and shape of the suspension only.

In order to prevent the vibrator from tilting and rolling, two or more suspensions may be used. However, in this case, the vibration resonance frequency may be increased. In addition, since it is difficult to maintain a flatness of each suspension and keep suspensions level to each other, an unstable vibration is generated.

### SUMMARY OF THE INVENTION

One or more aspects of the present invention provide multifunctional micro speakers that include a suspension for supporting a speaker magnetic circuit and having a bending shape instead of a plate shape, thereby preventing an unstable vibration of the speaker magnetic circuit.

One or more aspects of the present invention provide multifunctional micro speakers that have an improved restoring force when a vibrator vibrates, and an increased contact area between a suspension and a frame.

According to an aspect of the present invention, there is provided a multifunctional micro speaker including a frame including a lower plate portion and a lateral wall portion; a diaphragm having an outer circumferential portion that is fixed to the lateral wall portion of the frame; a voice coil fixed to a lower surface of the diaphragm; a suspension including a central portion and a supporting portion, wherein the central portion has a lower surface that is closely fixed to a lower plate member disposed in a lower portion of the frame, and the supporting portion extends from at least a portion of an outer circumferential portion of the central portion and is bent; a yoke fixed to the supporting portion of the suspension; a permanent magnet fixed to a bottom surface of the yoke; and a plate fixed to an upper surface of the permanent magnet.

The supporting portion of the suspension may include at least three branches that are spaced apart from each other by a predetermined interval along an outer circumferential portion of the central portion, extends from the central portion, and is bent inwards.

The number of the branches of the supporting portion may be 6, and each branch may extend from the central portion and may be bent so that bent portions constituted by at least two radiuses of curvature.

An upper end portion of the yoke is supported by an end portion of each branch of the supporting portion.

Each branch of the supporting portion of the suspension may extend from the central portion and is bent inwards, a portion of a bent portion may be formed in parallel to the central portion, and a lower surface of a central portion of the yoke may be fixed to an upper surface of each branch of the supporting portion.

The yoke may include the central portion and a lateral wall portion, and any one of a weight member for exerting weight and a porous acoustic absorbent may be disposed on the lateral wall portion of the yoke.

The multifunctional micro speaker may further include a magnet or coil that is disposed on the central portion of the suspension and is spaced apart from the yoke.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a conventional multifunctional micro speaker;

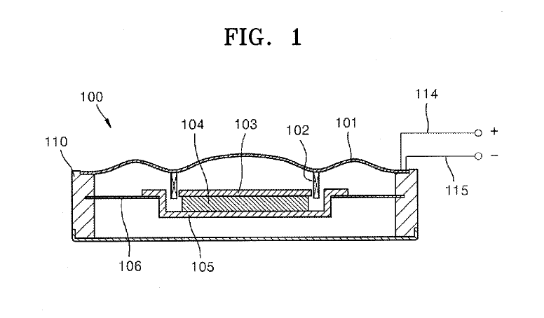

FIG. 2 is a schematic cross-sectional view of a multifunctional micro speaker according to an embodiment of the present invention;

FIG. 3 is a schematic top plan view of the multifunctional micro speaker of FIG. 2 except a diaphragm part, when an upper portion of a frame and a diaphragm are not illustrated; and

FIG. 4 is a schematic cross-sectional view of a multifunctional micro speaker according to another embodiment of the present invention.

### DETAILED DESCRIPTION OF THE INVENTION

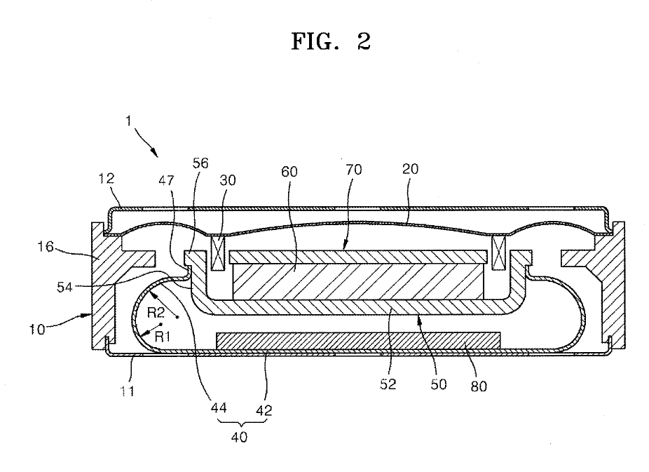

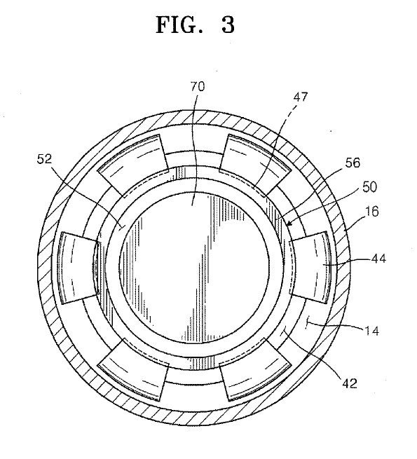

A multifunctional micro speaker according to an embodiment of the present invention will be described in detail with reference to FIGS. 2 and 3.

FIG. 2 is a schematic cross-sectional view of a multifunctional micro speaker 1 according to an embodiment of the present invention. FIG. 3 is a schematic top plan view of the multifunctional micro speaker 1 of FIG. 2 except a diaphragm part, when an upper portion of a frame 10 and a diaphragm 20 are not illustrated.

The multifunctional micro speaker 1 is mainly used in mobile communication devices such as cellular phones, or small-sized devices such as portable multimedia players (PMPs), and has both a function of generating a sound, like a speaker, and a function of generating a vibration, as a signal.

The multifunctional micro speaker 1 includes the frame 10, the diaphragm 20, a voice coil 30, a suspension 40, a yoke 50, a permanent magnet 60, and a plate 70.

The frame 10 is generally formed of plastic and forms an outer appearance of the multifunctional micro speaker 1. Various components are fixed to an inner part of the frame 10. The frame 10 includes an upper cover 12 disposed thereon, and a lower member 14 disposed therebelow. A plurality of vents are formed through the upper cover 12 and the lower member 14.

According to the present embodiment, the frame 10 has an overall cylindrical shape. However, according to another embodiment of the present invention, the frame 10 may have an overall rectangular-pillar shape that is unfilled and flat. When the frame 10 has a rectangular-pillar shape, components installed in the frame 10 may have a rectangular-pillar shape so as to correspond to the frame 10.

The diaphragm 20 generates a sound pressure that is audible to human ears while vibrating vertically. An outer circumferential portion of the diaphragm 20 is fixed between the upper cover 12 and the lateral wall 16 of the frame 10. The diaphragm 20 is generally formed of a high-molecular weight compound. The diaphragm 20 may be changed in various ways in terms of shape, material and thickness.

The voice coil 30 is fixed to a lower surface of the diaphragm 20. An upper end portion of the voice coil 30 is fixed to a lower surface of a boundary portion between outer and inner portions of the diaphragm 20. The voice coil 30 is formed by winding a wire in an upward direction. The voice coil 30 is electrically connected to a terminal (not shown) included in the frame 10. The voice coil 30 receives a current from an external source through the terminal.

A lower portion of the voice coil 30 is disposed in a gap (a magnetic gap) between the plate 70 and the yoke 50. When a high-frequency voice-signal current flows through the voice coil 30, the voice coil 30 moves up and down due to interaction between the high-frequency voice-signal current and a magnetic field formed by the permanent magnet 60. Thus, the diaphragm 20 coupled to the voice coil 30 vibrates, thereby generating a sound.

The suspension 40 supports a vibrator (a magnetic circuit) including the yoke 50, the permanent magnet 60, and the plate 70 so that the vibrator may vibrate. Conventionally, the suspension 40 has a flat shape. However, according to the present embodiment, the suspension 40 may have a bending shape. The suspension 40 may control a vibration of the magnetic circuit (the vibrator) by using structural shape recovery characteristics as well as a predetermined elasticity. In this case, the structural shape recovery characteristics and the predetermined elasticity are the characteristics of the suspension 40 itself.

The suspension 40 includes a central portion 42 and a supporting portion 44. The suspension 40 is formed of an elastic material, for example, plastic or metal.

A lower surface of the central portion 42 is closely fixed to the lower member 14 of the frame 10. According to the present embodiment, the central portion 42 has a circular shape. Referring to FIG. 2, a diameter of the central portion 42 may be slightly greater than an external diameter of an upper end portion of the yoke 50. The central portion 42 may be changed in various ways in terms of size and shape, in consideration of a shape of the supporting portion 44 and a restoring force of the suspension 40.

The supporting portion 44 extends from an outer circumferential portion of the central portion 42 and is bent. According to the present embodiment, the supporting portion 44 consists of six branches that are spaced apart from each other by a predetermined interval along the outer circumferential portion of the central portion 42.

Each branch of the supporting portion 44 extends from a portion of the outer circumferential portion of the central portion 42 along an imaginary circular arc whose center is a first point R1 that is positioned above the central portion 42 in the suspension 40, and is smoothly bent.

Each branch of the supporting portion 44 extends along another imaginary circular arc whose center is a second point R1 that is positioned higher than the first point R1, with respect to a central portion of the central portion 42, and is smoothly bent. In addition, an end portion 47 of the suspension 40 is bent so as to have a surface perpendicular to an upward direction.

That is, each branch of the supporting portion 44 may be bent so that the bent portions constituted by at least two radiuses of curvature. A restoring force generated due to a shape of each branch of the supporting portion 44 may be controlled by adjusting each radius of curvature when the supporting portion 44 is formed.

In consideration of a restoring force, balance, and processability, the number of the branches of the supporting portion 44 may be six, according to the present embodiment. However, the number of the branches of the supporting portion 44 may be three or more. If the number of the branches of the supporting portion 44 is two, problems may arise with overall balance. Thus, three or more branches of the supporting portion 44 may be used.

The shape of each branch of the supporting portion 44 may be changed in various ways as long as a restoring force may be generated due to a structure of the branch of the supporting portion 44. According to another embodiment of the present invention, the shape and number of each branch of the supporting portion 44 may be changed in various ways, in consideration of a required elastic force, balance, tilting, rolling, and the like.

The yoke 50 includes a bottom surface 52, and a lateral wall portion 54 that extends from an outer circumferential portion of the bottom surface 52 in an upward direction. An upper end portion 56 of the lateral wall portion 54 of the yoke 50 extends outwards in a horizontal direction.

According to the present embodiment, the upper end portion 56 of the yoke 50 is fixed to the end portion 47 of the branch of the supporting portion 44 of the suspension 40. The permanent magnet 60 and the plate 70 are disposed in a receiving groove that is formed to have a concave shape in the yoke 50. The yoke 50 is formed of a material through which a magnetic force is smoothly transmitted.

The permanent magnet 60 is fixed to an inner portion of the receiving groove of the yoke 50. The permanent magnet 60 has a disk shape and is fixed to the bottom surface 52 of the yoke 50.

The plate 70 has a diameter that is slightly greater than the permanent magnet 60 and is fixed to an upper surface of the permanent magnet 60. The plate 70 is formed of a material through which a magnetic force is smoothly transmitted.

The permanent magnet 60 and the plate 70 are spaced apart from an internal surface of the lateral wall portion 54 of the yoke 50 and are fixed to the yoke 50. A gap referred to as a magnetic gap is formed between vertical external surfaces of the permanent magnet 60 and the plate 70, and the internal surface of the lateral wall portion 54 of the yoke 50. The lower portion of the voice coil 30 is disposed in the space.

The permanent magnet 60, the plate 70, and the yoke 50 constitute a magnetic circuit, and simultaneously, constitute a vibrator that is supported by the suspension 40 and vibrates. A magnetic flux generated by the permanent magnet 60 forms a magnetic flux path that is transmitted to the yoke 50 through the plate 70.

The multifunctional micro speaker 1 may further include a magnet or coil 80. If necessary, the multifunctional micro speaker 1 may include a permanent magnet, or a coil functioning as an electromagnetic magnet.

The magnet or coil 80 is disposed on an upper surface of the central portion 42 of the suspension 40. The magnet or coil 80 is spaced apart from the yoke 50 so as not to contact the yoke 50 even though the magnet or coil 80 vibrates.

A direction of a magnetic field generated by the magnet or coil 80 may be controlled so that a repulsive or attractive force may act on a magnetic field generated by the permanent magnet 60 included in the yoke 50, thereby controlling a displacement of the vibrator as the magnetic circuit to a desired degree. According to another embodiment of the present invention, the magnet or coil 80 may be omitted.

Hereinafter, the operation and effect of the multifunctional micro speaker 1 will be described.

The multifunctional micro speaker 1 is characterized in that the suspension 40 for supporting the magnetic circuit constituting the vibrator has a bending shape. Conventionally, since a suspension included in a multifunctional micro speaker has a plate shape, a thickness of the suspension, a shape of a cut portion of a plate, or the like is inevitably changed in order to control a degree of an amplitude or restoring force, or vibration balance. Various problems arise due to these changes. Accordingly, the multifunctional micro speaker 1 includes the suspension having a 3D shape in order to overcome the various problems.

That is, since the multifunctional micro speaker 1 includes the suspension 40 having a shape similar to a bowl, the structural shape recovery characteristics of the suspension 40 may be used, thereby preventing an unstable vibration such as tilting or rolling of the magnetic circuit constituting the vibrator.

A contact area between the suspension 40 and the frame 10 may be increased to thus improve a restoring force when the vibrator vibrates.

A resonance frequency of the vibrator may be controlled by adjusting the number of branches of the supporting portion 44 as well as the thickness of the suspension 40.

A resonance frequency and a vibration amplitude of the vibrator may be controlled by adjusting a radius of curvature of a bent portion of each branch of the suspension 40. In addition, an amplitude that is measured vertically may be controlled by using an asymmetric compression repelling force of the suspension 40.

When the multifunctional micro speaker 1 further includes the magnet or coil 80 disposed below the magnetic circuit, a displacement of the vibrator may be controlled by using a repulsive or attractive force acting on a magnetic field generated by the magnet or coil 80.

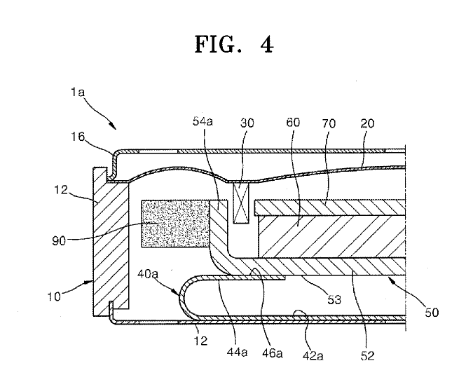

FIG. 4 is a schematic cross-sectional view of a multifunctional micro speaker 1a according to another embodiment of the present invention. The multifunctional micro speaker 1a is symmetrical about a central axis, and thus half of the multifunctional micro speaker 1 a is shown only.

The multifunctional micro speaker 1a of FIG. 4 is different from the multifunctional micro speaker 1 of FIG. 2 in that a shape of each branch of a supporting portion 44a of a suspension 40a, and a shape of a yoke 50a are changed, and a weight member or porous acoustic absorbent 90 is further included.

That is, each branch of the supporting portion 44a of the suspension 40a extends from a central portion 42a and is bent inwards. In this case, a portion of the bent portion is formed in parallel to the central portion 42a. That is, the branch of the supporting portion 44a extends from an outer circumferential portion of the central portion 42a, is bent to form a semicircle, and extends again in parallel to the central portion 42a. A size of the semicircle may be appropriately determined in consideration of a restoring force, or the like.

A bottom surface 53 of a central portion 52 of the yoke 50a is fixed to an upper surface 46a of the branch of the supporting portion 44a. The yoke 50a includes a lateral wall portion 54a that extends from an outer circumferential portion of the central portion 52 in an upward direction.

According to the present embodiment, the weight member or porous acoustic absorbent 90 is disposed on an external lateral surface of the lateral wall portion 54a of the yoke 50a.

A weight member is a member for exerting weight onto the vibrator. An acoustic absorbent is a member that is formed of a material with many pores formed therein and controls an acoustic load. If necessary, the weight member or the acoustic absorbent 90 may be used, or alternatively, a member functioning as both the weight member and the acoustic absorbent 90 may be used.

According to the present embodiment, since the suspension 40a is configured to be small in volume, the magnetic circuit may be changed in various ways. In addition, it is easy to install the weight member or porous acoustic absorbent 90 at one side of the vibrator.

In the multifunctional micro speaker 1a, the same operation and effect may be obtained due to the same construction except for that described above, as the multifunctional micro speaker 1 of FIG. 2.

According to one or more embodiments of the present invention, a multifunctional micro speaker includes a suspension having a 3D shape, thereby preventing an unstable vibration of a magnetic circuit.

In addition, a contact area between a suspension and a frame is increased to thus improve a restoring force when a vibrator vibrates.

Moreover, a contact area with the magnetic circuit is adjusted according to a bending degree of each branch of a supporting portion and the number of branches of the supporting portion to thus control vibration characteristics of the vibrator.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multifunctional micro speaker comprising:
a frame comprising a lower plate portion and a lateral wall portion;
a diaphragm having an outer circumferential portion that is fixed to the lateral wall portion of the frame;
a voice coil fixed to a lower surface of the diaphragm;
a suspension comprising a central portion and a supporting portion, wherein the central portion has a lower surface that is closely fixed to a lower plate member disposed in a lower portion of the frame, and the supporting portion extends from at least a portion of an outer circumferential portion of the central portion and is bent;
a yoke fixed to the supporting portion of the suspension;
a permanent magnet fixed to a bottom surface of the yoke; and
a plate fixed to an upper surface of the permanent magnet.

2. The multifunctional micro speaker of claim 1, wherein the supporting portion of the suspension comprises at least three branches that are spaced apart from each other by a predetermined interval along an outer circumferential portion of the central portion, extends from the central portion, and is bent inwards.

3. The multifunctional micro speaker of claim 2, wherein the number of the branches of the supporting portion is 6,
wherein each branch extends from the central portion and is bent so that bent portions constituted by at least two radiuses of curvature.

4. The multifunctional micro speaker of claim 2, wherein an upper end portion of the yoke is supported by an end portion of each branch of the supporting portion.

5. The multifunctional micro speaker of claim 2, wherein each branch of the supporting portion of the suspension extends from the central portion and is bent inwards, wherein a portion of a bent portion is formed in parallel to the central portion, and
wherein a lower surface of a central portion of the yoke is fixed to an upper surface of each branch of the supporting portion.

6. The multifunctional micro speaker of claim 5, wherein the yoke comprises the central portion and a lateral wall portion, and
wherein any one of a weight member for exerting weight and a porous acoustic absorbent is disposed on the lateral wall portion of the yoke.

7. The multifunctional micro speaker of claim 1, further comprising a magnet or coil that is disposed on the central portion of the suspension and is spaced apart from the yoke.
